(19) United States
(12) Patent Application Publication
(10) Pub. No.: US 2014/0272843 A1
(43) Pub. Date: Sep. 18, 2014

(54) COGNITIVE EVALUATION AND DEVELOPMENT SYSTEM WITH CONTENT ACQUISITION MECHANISM AND METHOD OF OPERATION THEREOF

(71) Applicant: HEALTHTECHAPPS, INC., Honolulu, HI (US)

(72) Inventors: Eleanor Noelani Foster, Honolulu, HI (US); Kyle Nainoa Manuma Chang, Honolulu, HI (US); Brian Dote, Honolulu, HI (US)

(73) Assignee: HealthTechApps, Inc., Honolulu, HI (US)

(21) Appl. No.: 13/843,813

(22) Filed: Mar. 15, 2013

(51) Int. Cl. G09B 5/02

(52) U.S. Cl. CPC G09B 5/02
USPC 434/236

(57) ABSTRACT

A system and method of operation of a cognitive evaluation and development system includes: a cognitive puzzle having a video tile; a media clip linked to the video tile; a cognitive task based on the media clip; a user generated content based on the cognitive task; and a cognitive response message based on the user generated content for displaying on the device.

### TECHNICAL FIELD

The present invention relates generally to an evaluation and development system, and more particularly to a system with cognitive content acquisition.

### BACKGROUND ART

Modern portable consumer, industrial, and medical electronics, especially client devices such as tablet computers, laptops, smart phones, portable digital assistants, and combination devices, are providing increasing levels of functionality to support modern life including healthcare services. Research and development in the existing technologies can take a myriad of different directions.

As users become more empowered with the growth of portable computing devices, new and old paradigms begin to take advantage of this new device space. There are many technological solutions to take advantage of this new device functionality opportunity. One existing approach is to evaluate patient medical profile information to gather and provide personalized content through a mobile device such as a tablet, a smart phone, or a personal digital assistant.

Medical evaluation services allow users to create, transfer, store, and/or consume medical information in order for users and healthcare providers to create, transfer, store, and consume in the “real world.” One such use of medical evaluation services is to efficiently guide users to the desired product, treatment, medical solution, or service.

Medical evaluation systems and personalized content management services enabled systems have been incorporated in dedicated medical devices, computers, smart phones, handheld devices, and other products. Today, these systems aid users by managing real-time medically relevant information, such as blood pressure, pulse, blood chemistry, or other medical factors.

However, a medical evaluation and development system for cognitive function has become a paramount concern for the medical consumer. The inability to provide systems decreases the benefit of using the tool.

Thus, a need still remains for a medical evaluation and development system with a cognitive content acquisition mechanism. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, improve the quality of communication between physicians and healthcare consumers, and improve consumer engagement, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a cognitive evaluation and development system including: presenting a cognitive puzzle; selecting a video tile of the cognitive puzzle, the video tile enabled by solving the cognitive puzzle; presenting a media clip linked to the video tile, the media clip for displaying on a device; providing a cognitive task linked to the media clip; acquiring a user generated content in response to the cognitive task; and presenting a cognitive response message based on the user generated content for displaying on the device.

The present invention provides a cognitive evaluation and development system, including: a cognitive puzzle having a video tile; a media clip linked to the video tile; a cognitive task based on the media clip; a user generated content based on the cognitive task; and a cognitive response message based on the user generated content for displaying on the device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a cognitive evaluation and development system with content acquisition mechanism in an embodiment of the present invention.

FIG. 2 is an example of a display of the cognitive evaluation and development system.

FIG. 3 is an example of the first imaging unit of the cognitive evaluation and development system.

FIG. 4 is a first example of the display of the video tiles.

FIG. 5 is a second example of the display of the video tiles.

FIG. 6 is an example of the display of a media clip.

FIG. 7 is an example of the display of a cognitive task.

FIG. 8 is an example of the display of a user generated content.

FIG. 9 is an example of the display of a push notification.

FIG. 10 is an example of the display of a cognitive response message.

FIG. 11 is an example of the display for storing the user generated content.

FIG. 12 is an example of the display of a user survey.

FIG. 13 is an example of the display of a heath survey.

FIG. 14 is a functional block diagram of the cognitive evaluation and development system.

FIG. 15 is a control flow of the cognitive evaluation and development system.

FIG. 16 is a flow chart of a method of operation of the cognitive evaluation and development system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGS. Similarly, although the views in the drawings for ease of description generally show similar orientations, this depiction in the FIGS. is arbitrary for the most part. Generally, the invention can be operated in any orientation. The embodiments have been numbered first embodiment, second embodiment, etc. as a matter of descriptive convenience and are not intended to have any other significance or provide limitations for the present invention. Where multiple embodiments are disclosed and described having some features in common, for clarity and ease of illustration, description, and comprehension thereof, similar and like features one to another will ordinarily be described with similar reference numerals.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown a cognitive evaluation and development system 100 with content acquisition mechanism in an embodiment of the present invention. The cognitive evaluation and development system 100 includes a first device 102, such as a client or a server, connected to a second device 104, such as a client or server, with a communication path 106, such as a wireless or wired network.

For example, the first device 102 can be of any of a variety of mobile devices, such as a tablet computer, smart phone, personal digital assistant, a notebook computer, medical system, or other multi-functional computing device. The first device 102 can be a standalone device, or can be incorporated with a medical instrumentation system. The first device 102 can couple to the communication path 106 to communicate with the second device 104.

For illustrative purposes, the cognitive evaluation and development system 100 is described with the first device 102 as a mobile computing device, although it is understood that the first device 102 can be different types of computing devices. For example, the first device 102 can also be a non-mobile computing device, such as a server, a server farm, or a desktop computer. In another example, the first device 102 can be a non-mobile computing device, such as a desktop computer, server, medical device, or a computer terminal.

The second device 104 can be any of a variety of centralized or decentralized computing devices. For example, the second device 104 can be a computer, grid computing resources, a virtualized computer resource, cloud computing resource, routers, switches, peer-to-peer distributed computing devices, or a combination thereof.

The second device 104 can be centralized in a single computer room, distributed across different rooms, distributed across different geographical locations, or embedded within a telecommunications network. The second device 104 can have a means for coupling with the communication path 106 to communicate with the first device 102. The second device 104 can also be a client type device as described for the first device 102.

In another example, the first device 102 can be a particularized machine, such as a mainframe, a server, a cluster server, rack mounted server, or a blade server, or as more specific examples, an IBM System z10™ Business Class mainframe or a HP ProLiant ML™ server. Yet another example, the second device 104 can be a particularized machine, such as a portable computing device, a thin client, a notebook, a netbook, a smartphone, personal digital assistant, or a cellular phone, and as specific examples, an Apple iPhone™, Apple iPad™, Samsung Galaxy™, or Moto Q Global™.

For illustrative purposes, the cognitive evaluation and development system 100 is described with the second device 104 as a non-mobile computing device, although it is understood that the second device 104 can be different types of computing devices. For example, the second device 104 can also be a mobile computing device, such as notebook computer, another client device, or a different type of client device. The second device 104 can be a standalone device, or can be incorporated with a medical instrumentation system.

Also for illustrative purposes, the cognitive evaluation and development system 100 is shown with the second device 104 and the first device 102 as end points of the communication path 106, although it is understood that the cognitive evaluation and development system 100 can have a different partition between the first device 102, the second device 104, and the communication path 106. For example, the first device 102, the second device 104, or a combination thereof can also function as part of the communication path 106. The cognitive evaluation and development system 100 can be implemented with a device, such as the first device 102, the second device 104, or a combination thereof.

The communication path 106 can be a variety of networks. For example, the communication path 106 can include wireless communication, wired communication, optical, ultrasonic, or the combination thereof. Satellite communication, cellular communication, Bluetooth, Infrared Data Association standard (IrDA), near field communication (NFC), wireless fidelity (WiFi), and worldwide interoperability for microwave access (WiMAX) are examples of wireless communication that can be included in the communication path 106. Ethernet, digital subscriber line (DSL), fiber to the home (FTTH), and plain old telephone service (POTS) are examples of wired communication that can be included in the communication path 106.

Further, the communication path 106 can traverse a number of network topologies and distances. For example, the communication path 106 can include direct connection, personal area network (PAN), local area network (LAN), metropolitan area network (MAN), wide area network (WAN) or any combination thereof.

The cognitive evaluation and development system 100 can include a content management system 108. The content management system 108 is a data storage and retrieval mechanism for processing the content. The content management system 108, such as a local storage system or a cloud-based content management system, is shown as a part of the second device 104, but it is understood that the content management system 108 can have different configuration and can be part of the first device 102, the second device 104, or part of an external system (not shown).

Referring now to FIG. 2, therein is shown an example of a display of the cognitive evaluation and development system 100 of FIG. 1. The cognitive evaluation and development system 100 can display a cognitive puzzle 202 on a first display interface 210 of the first device 102.

The cognitive puzzle 202 is an interactive user interface. The cognitive evaluation and development system 100 can be configured to perform an action once the cognitive puzzle 202 has been solved. A user can solve the cognitive puzzle 202 before continuing to a subsequent operation in the cognitive evaluation and development system 100.

The cognitive puzzle 202 can include video tiles 204 arranged in a grid. The video tiles 204 are icons that can link to multi-media content. Each of the video tiles 204 can include a tile graphic 206 representing a portion of a solution picture 208. The solution picture 208 is an image represented by all of the video tiles 204 in the grid. For example, the solution picture 208 can be an image of a heart within a heart, a geometric shape, an image, a photograph, a video recording, active content, or a combination thereof. The cognitive puzzle 202 having the video tiles 204 and the solution picture 208 can be presented on the first display interface 210. Presenting can include displaying a picture, displaying a video element, playing an audio element, or a combination thereof.

Referring now to FIG. 3, therein is shown an example of a first imaging unit 302 of the cognitive evaluation and development system 100 of FIG. 1. The cognitive evaluation and development system 100 can include the first imaging unit 302 for capturing still pictures and video content.

The first imaging unit 302 can is an optical device for capturing images. For example, the first imaging unit 302 can be a digital camera, video camera, image sensor, or a combination thereof. The first imaging unit 302 can be located on the same side of the device as the first display interface 210 or located on the back side of the first device 102.

The first imaging unit 302 can include a lighting unit 308 to illuminate a scene to help capture the picture. For example, the lighting unit 308 can be a flash, light source, light emitting diode, or a combination thereof.

The cognitive evaluation and development system 100 can include a first audio unit 310. The first audio unit 310 is a mechanism for capturing and recording sounds. For example, the first audio unit 310 can be a microphone, audio sensor, headset, or a combination thereof.

Referring now to FIG. 4, therein is shown a first example of the display of the cognitive puzzle 202 of the cognitive evaluation and development system 100 of FIG. 1. The cognitive puzzle 202 can include the video tiles 204 representing the solution picture 208 of FIG. 2 with each of the video tiles 204 having a portion of the solution picture 208. Each of the video tiles 204 can include the tile graphic 206 representing a portion of the solution picture 208.

The cognitive puzzle 202 can be configured to arrange the video tiles 204 in a pre-defined or scrambled sequence to prevent clear viewing of the solution picture 208. The cognitive puzzle 202 can be solved by dragging, moving, swapping, arranging, or otherwise manipulating the location of each of the video tiles 204 until the video tiles 204 form a representation of the solution picture 208.

Referring now to FIG. 5, therein is shown a second example of a display of the cognitive puzzle 202 of the cognitive evaluation and development system 100 of FIG. 1. The cognitive puzzle 202 can be solved by arranging the video tiles 204 to display the solution picture 208.

When the video tiles 204 are arranged to form the solution picture 208, each of the video tiles 204 can be configured to enable a link to a multi-media content. Activating one the video tiles 204 can cause the multi-media content to be displayed on the first display interface 210 of the first device 102.

The video tiles 204 can be activated by touching, tapping, clicking, or selecting the desired one of the video tiles 204. The cognitive puzzle 202 can highlight the video tiles 204 that have been selected. The video tiles 204 that have been highlighted can have a visual representation of being selected such as, a still screenshot of a portion of the video, bolding, change of color, change of contrast, active content, or a combination thereof.

Referring now to FIG. 6, therein is shown the display of a media clip 602. The cognitive evaluation and development system 100 of FIG. 1 can link the media clip 602 to the activation of one of the video tiles 204 of FIG. 2. By activating the one of the video tiles 204, the media clip 602 can be displayed on the first display interface 210 of the first device 102.

The media clip 602 can be a mini-movie, video element, a slide show, animation, live video feeds, an audio clip, or a combination thereof. The media clip 602 can be provided as a local file, a remote file, a streaming feed, or a combination thereof.

The media clip 602 can be linked to a task to be performed by the user. The media clip 602 can include an identification of the content that can be linked to other content, information, user profiles, or other information in the cognitive evaluation and development system 100.

The media clip 602 can be displayed using a media interface, such as a browser or media player. The media interface can provide control features controlling the display of the media clip 602 such as play, back, forward, fast forward, pause, stop, next, goto end, change speed, or a combination thereof.

Referring now to FIG. 7, therein is shown the display of a cognitive task 702. The cognitive evaluation and development system 100 of FIG. 1 can display the cognitive task 702 based on the media clip 602 of FIG. 6.

The cognitive task 702 can be an evaluation task for determining or influencing the cognitive status of the user. For example, the cognitive task 702 can be a task to take a picture linked to a theme shown within the media clip 602, such as taking a picture of a boat at sunset after showing the media clip 602 of a person at the seashore with boats in the background.

The cognitive task 702 can include actions such as taking a photo at a location, making a video about a particular topic, entering text information in response to a question presented in the video including, but not limited to, a mental condition or state, or a text acknowledgement that the user has performed a particular action as directed, or a combination thereof. The cognitive task 702 can be linked to other content, information, user profiles, device location tracking, or other information in the cognitive evaluation and development system 100.

The cognitive task 702 can be received from a remote system, provided locally from the first device 102, or a combination thereof. The cognitive task 702 can be displayed on the first display interface 210 of the first device 102. Although the cognitive task 702 is shown as text, it is understood that the cognitive task 702 can be provided in a variety of ways including text, photo, audio, video, or a combination thereof.

Referring now to FIG. 8, therein is shown an example of the display of a user generated content 802. The cognitive evaluation and development system 100 of FIG. 1 can acquire the user generated content 802 in response to the cognitive task 702 of FIG. 7 and the media clip 602 of FIG. 6.

The user generated content 802 is media content created using the cognitive evaluation and development system 100. The user generated content 802 can include a media type 804 such as image, digital photographs, video, text, audio, drawings, animation, motion capture, or a combination thereof. The user generated content 802 can be generated using camera, video camera, audio recorder, keyboard, touch screen, or a combination thereof.

For example, the user generated content 802 can be a picture or video of a boat at sunset taken using the camera on a smart phone. In another example, the user generated content 802 can be text entered on the first device 102, such as a statement about an individual's cognitive status, a text response to a question posed in the video, an acknowledgement that a particular action has been completed by the user, or a combination thereof. In yet another example, the user generated content 802 can be an audio recording.

Referring now to FIG. 9, therein is shown an example of the display of a push notification 902. The cognitive evaluation and development system 100 of FIG. 1 can display the push notification 902 on the first device 102 to notify the user of an event. The push notification 902 is a message generated by the cognitive evaluation and development system 100. For example, the push notification 902 can be a message acknowledging that the user generated content 802 of FIG. 8 has been acquired.

Referring now to FIG. 10, therein is shown an example of the display of a cognitive response message 1002. The cognitive response message 1002 is a response based on the user generated content 802 of FIG. 8.

The cognitive response message 1002 can include a variety of types of content. For example, the cognitive response message 1002 can include a message to perform a cognitive exercise, such as reading a document. In another example, the cognitive response message 1002 can be a progress message describing the current status of the user.

In yet another example, the cognitive response message 1002 can be a motivational statement intended to calm or encourage the user. In still another example, the cognitive response message 1002 can be an assessment of the user generated content 802 in light of the users' cognitive status.

The cognitive response message 1002 can be formed in a variety of ways. For example, the cognitive response message 1002 can be generated by applying a set of rules to the user generated content 802 and the device location to determine compliance of the user generated content 802 with the cognitive task 702 of FIG. 7.

In another example, the cognitive response message 1002 can be formed as a selection from a database having a set of the cognitive response message 1002 based on statistical results from the on-going operation of the cognitive evaluation and development system 100. In yet another example, the cognitive response message 1002 can be formed manually based on the user generated content 802, the cognitive task 702, and the device location.

In yet another example, the cognitive response message 1002 can be formed based on the similarity between the user generated content 802 and the media clip 602. The cognitive response message 1002 can have a positive reinforcing message when the user generated content 802 is similar to the media clip 602, such as when the media clip 602 includes images of birds and the media clip 602 includes images of birds. Similarity is defined as having common elements.

In still another example, the cognitive response message 1002 can be formed based on the dissimilarity between the user generated content 802 and the media clip 602. The cognitive response message 1002 can have a negative reinforcing message when the user generated content 802 is not similar to the media clip 602, such as when the media clip 602 includes images of birds and the user generated content 802 does not includes images of birds. Dissimilarity is defined as not having common elements.

Referring now to FIG. 11, therein is shown an example of the display for the storing of the user generated content 802 of FIG. 8. The cognitive evaluation and development system 100 of FIG. 1 can display a share content message 1102 on the first device 102. If the user selects the share content message 1102, then the user generated content 802 can be shared to a social network. The user generated content 802 that is shared can be used to form the media clip 602.

The cognitive evaluation and development system 100 can display a no-share content message 1104 on the first device 102. If the user selects the no-share content message 1104, then the user generated content 802 can be stored on a private local storage device, marked private in the content management system 108 of FIG. 1. The user generated content 802 designated as no-share is not made available to others.

Referring now to FIG. 12, therein is shown an example of the display of a user survey 1202. The user survey 1202 is a query to receive inputs to identify the user. The user survey 1202 can support data entry of information about a user profile 1204. The user profile 1204 can include information such as name, age, sex, military service, medical history, symptoms, experiences, injuries, or a combination thereof. The user profile 1204 can be stored locally or remotely, such as in cloud storage.

The user profile 1204 can include a user identification 1206. The user identification 1206 is a value used to indicate the user. The user identification 1206 can be associated with other information in the cognitive evaluation and development system 100 of FIG. 1 to link the information to the particular user.

Referring now to FIG. 13, therein is shown an example of the display of a health survey 1302. The health survey 1302 is a query to receive inputs to describe the health of the user at a particular time. The health survey 1302 can support data entry of information about a health profile 1304. The health profile 1304 can include information such as user identification, age, medical profile information, relevant trigger events, symptoms, injuries, current date, or a combination thereof. The health profile 1304 can be stored locally or remotely, such as in the content management system 108 of FIG. 1.

Referring now to FIG. 14, therein is shown a functional block diagram of the cognitive evaluation and development system 100. The cognitive evaluation and development system 100 can include the first device 102, the communication path 106, and the second device 104.

The first device 102 can communicate with the second device 104 over the communication path 106. The second device 104 can communicate with the first device 102 over the communication path 106.

For illustrative purposes, the cognitive evaluation and development system 100 is shown with the first device 102 as a client device, although it is understood that the cognitive evaluation and development system 100 can have the first device 102 as a different type of device. For example, the first device 102 can be a server.

Also for illustrative purposes, the cognitive evaluation and development system 100 is shown with the second device 104 as a server, although it is understood that the cognitive evaluation and development system 100 can have the second device 104 as a different type of device. For example, the second device 104 can be a client device.

For brevity of description in this embodiment of the present invention, the first device 102 will be described as a client device, such as a smart phone. The present invention is not limited to this selection for the type of devices. The selection is an example of the present invention.

The first device 102 can include a first control unit 1412. The first control unit 1412 can include a first control interface 1428. The first control unit 1412 can execute a first software 1420 to provide the intelligence of the cognitive evaluation and development system 100.

The first control unit 1412 can be implemented in a number of different manners. For example, the first control unit 1412 can be a processor, an embedded processor, a microprocessor, a hardware control logic, a hardware finite state machine (FSM), a digital signal processor (DSP), or a combination thereof.

The first control interface 1428 can be used for communication between the first control unit 1412 and other functional units in the first device 102. The first control interface 1428 can also be used for communication that is external to the first device 102.

The first control interface 1428 can receive information from the other functional units or from external sources, or can transmit information to the other functional units or to external destinations. The external sources and the external destinations refer to sources and destinations external to the first device 102.

The first control interface 1428 can be implemented in different ways and can include different implementations depending on which functional units or external units are being interfaced with the first control interface 1428. For example, the first control interface 1428 can be implemented with electrical circuitry, microelectromechanical systems (MEMS), optical circuitry, wireless circuitry, wireline circuitry, or a combination thereof.

The first device 102 can include a first storage unit 1416. The first storage unit 1416 can store the first software 1420. The first storage unit 1416 can also store the relevant information, such as images, pictures, video, audio, text, maps, profiles, sensor data, location information, or any combination thereof.

The first storage unit 1416 can be a volatile memory, a nonvolatile memory, an internal memory, an external memory, or a combination thereof. For example, the first storage unit 1416 can be a nonvolatile storage such as non-volatile random access memory (NVRAM), Flash memory, disk storage, or a volatile storage such as static random access memory (SRAM).

The first storage unit 1416 can include a first storage interface 1432. The first storage interface 1432 can be used for communication between the first storage unit 1416 and other functional units in the first device 102. The first storage interface 1432 can also be used for communication that is external to the first device 102.

The first storage interface 1432 can receive information from the other functional units or from external sources, or can transmit information to the other functional units or to external destinations. The external sources and the external destinations refer to sources and destinations external to the first device 102.

The first storage interface 1432 can include different implementations depending on which functional units or external units are being interfaced with the first storage unit 1416. The first storage interface 1432 can be implemented with technologies and techniques similar to the implementation of the first control interface 1428.

The first device 102 can include a first communication unit 1406. The first communication unit 1406 can be for enabling external communication to and from the first device 102. For example, the first communication unit 1406 can permit the first device 102 to communicate with the second device 104, an attachment, such as a peripheral device or a computer desktop, and the communication path 106.

The first communication unit 1406 can also function as a communication hub allowing the first device 102 to function as part of the communication path 106 and not limited to be an end point or terminal unit to the communication path 106. The first communication unit 1406 can include active and passive components, such as microelectronics or an antenna, for interaction with the communication path 106.

The first communication unit 1406 can include a first communication interface 1422. The first communication interface 1422 can be used for communication between the first communication unit 1406 and other functional units in the first device 102. The first communication interface 1422 can receive information from the other functional units or can transmit information to the other functional units.

The first communication interface 1422 can include different implementations depending on which functional units are being interfaced with the first communication unit 1406. The first communication interface 1422 can be implemented with technologies and techniques similar to the implementation of the first control interface 1428.

The first device 102 can include a first user interface 1402. The first user interface 1402 allows a user (not shown) to interface and interact with the first device 102. The first user interface 1402 can include a first user input (not shown). The first user input can include touch screen, gestures, motion detection, buttons, sliders, knobs, virtual buttons, voice recognition controls, or any combination thereof.

The first user interface 1402 can include the first display interface 210. The first display interface 210 can allow the user to interact with the first user interface 1402. The first display interface 210 can include a display, a video screen, a speaker, or any combination thereof.

The first control unit 1412 can operate with the first user interface 1402 to display information generated by the cognitive evaluation and development system 100 on the first display interface 210. The first control unit 1412 can also execute the first software 1420 for the other functions of the cognitive evaluation and development system 100, including receiving display information from the first storage unit 1416 for display on the first display interface 210. The first control unit 1412 can further execute the first software 1420 for interaction with the communication path 106 via the first communication unit 1406.

The first device 102 can include a first location unit 1414. The first location unit 1414 can provide the location of the first device 102. The first location unit 1414 can access location information, current heading, and current speed of the first device 102, as examples.

The first location unit 1414 can be implemented in many ways. For example, the first location unit 1414 can function as at least a part of a global positioning system, an inertial navigation system, a cellular-tower location system, a pressure location system, or any combination thereof.

The first location unit 1414 can include a first location interface 1430. The first location interface 1430 can be used for communication between the first location unit 1414 and other functional units in the first device 102. The first location interface 1430 can also be used for communication that is external to the first device 102.

The first location interface 1430 can receive information from the other functional units or from external sources, or can transmit information to the other functional units or to external destinations. The external sources and the external destinations refer to sources and destinations external to the first device 102.

The first location interface 1430 can include different implementations depending on which functional units or external units are being interfaced with the first location unit 1414. The first location interface 1430 can be implemented with technologies and techniques similar to the implementation of the first control interface 1428.

The first device 102 can include a first position unit 1408. The first position unit 1408 can provide the position, motion, and orientation of the first device 102. The first position unit 1408 can access position information of the first device 102 including tilt, angle, direction, orientation, rotation, motion, acceleration, or a combination thereof.

The first position unit 1408 can be implemented in many ways. For example, the first position unit 1408 can be an accelerometer, a gyroscopic system, a MEMS system, an electrical contact system, an optical orientation system, or a combination thereof.

The first position unit 1408 can include a first position interface 1424. The first position interface 1424 can be used for communication between the first position unit 1408 and other functional units in the first device 102. The first position interface 1424 can also be used for communication that is external to the first device 102.

The first position interface 1424 can receive information from the other functional units or from external sources, or can transmit information to the other functional units or to external destinations. The external sources and the external destinations refer to sources and destinations external to the first device 102.

The first position interface 1424 can include different implementations depending on which functional units or external units are being interfaced with the first position unit 1408. The first position interface 1424 can be implemented with technologies and techniques similar to the implementation of the first control interface 1428.

The first device 102 can include the first imaging unit 302. The first imaging unit 302 can capture optical information at the first device 102 such as pictures, images, video, or a combination thereof. The first imaging unit 302 can include a digital camera, optical sensor, video camera, or a combination thereof.

The first imaging unit 302 can include a first imaging interface 1434. The first imaging interface 1434 can be used for communication between the first imaging unit 302 and other functional units in the first device 102. The first imaging interface 1434 can also be used for communication that is external to the first device 102.

The first imaging interface 1434 can include different implementations depending on which functional units or external units are being interfaced with the first imaging unit 302. The first imaging interface 1434 can be implemented with technologies and techniques similar to the implementation of the first control interface 1428.

The first device 102 can include the first audio unit 310. The first audio unit 310 can capture sound or other audio information at the first device 102. The first audio unit 310 can include a digital microphone, audio sensor, or a combination thereof.

The first audio unit 310 can include a first audio interface 1426. The first audio interface 1426 can be used for communication between the first audio unit 310 and other functional units in the first device 102. The first audio interface 1426 can also be used for communication that is external to the first device 102.

The first audio interface 1426 can include different implementations depending on which functional units or external units are being interfaced with the first audio unit 310. The first audio interface 1426 can be implemented with technologies and techniques similar to the implementation of the first control interface 1428.

For illustrative purposes, the first device 102 can be partitioned having the first user interface 1402, the first storage unit 1416, the first control unit 1412, and the first communication unit 1406, although it is understood that the first device 102 can have a different partition. For example, the first software 1420 can be partitioned differently such that some or all of its function can be in the first control unit 1412 and the first communication unit 1406. Also, the first device 102 can include other functional units, not shown in FIG. 14 for clarity.

The cognitive evaluation and development system 100 can include the second device 104. The second device 104 can be optimized for implementing the present invention in a multiple device embodiment with the first device 102. The second device 104 can provide the additional or higher performance processing power compared to the first device 102.

The second device 104 can include a second control unit 1452. The second control unit 1452 can include a second control interface 1468. The second control unit 1452 can execute a second software 1460 to provide the intelligence of the cognitive evaluation and development system 100.

The second control unit 1452 can be implemented in a number of different manners. For example, the second control unit 1452 can be a processor, an embedded processor, a microprocessor, a hardware control logic, a hardware finite state machine (FSM), a digital signal processor (DSP), or a combination thereof.

The second control interface 1468 can be used for communication between the second control unit 1452 and other functional units in the second device 104. The second control interface 1468 can also be used for communication that is external to the second device 104.

The second control interface 1468 can receive information from the other functional units or from external sources, or can transmit information to the other functional units or to external destinations. The external sources and the external destinations refer to sources and destinations external to the second device 104.

The second control interface 1468 can be implemented in different ways and can include different implementations depending on which functional units or external units are being interfaced with the second control interface 1468. For example, the second control interface 1468 can be implemented with electrical circuitry, microelectromechanical systems (MEMS), optical circuitry, wireless circuitry, wireline circuitry, or a combination thereof.

The second device 104 can include a second storage unit 1456. The second storage unit 1456 can store the second software 1460. The second storage unit 1456 can also store the relevant information, such as images, video, audio, maps, profiles, sensor data, location information, or any combination thereof.

The second storage unit 1456 can be a volatile memory, a nonvolatile memory, an internal memory, an external memory, or a combination thereof. For example, the second storage unit 1456 can be a nonvolatile storage such as non-volatile random access memory (NVRAM), Flash memory, disk storage, or a volatile storage such as static random access memory (SRAM).

The second storage unit 1456 can include a second storage interface 1472. The second storage interface 1472 can be used for communication between the second storage unit 1456 and other functional units in the second device 104. The second storage interface 1472 can also be used for communication that is external to the second device 104.

The second storage interface 1472 can receive information from the other functional units or from external sources, or can transmit information to the other functional units or to external destinations. The external sources and the external destinations refer to sources and destinations external to the second device 104.

The second storage interface 1472 can include different implementations depending on which functional units or external units are being interfaced with the second storage unit 1456. The second storage interface 1472 can be implemented with technologies and techniques similar to the implementation of the second control interface 1468.

The second device 104 can include a second communication unit 1446. The second communication unit 1446 can enable external communication to and from the second device 104. For example, the second communication unit 1446 can permit the second device 104 to communicate with the first device 102, an attachment, such as a peripheral device or a computer desktop, and the communication path 106.

The second communication unit 1446 can also function as a communication hub allowing the second device 104 to function as part of the communication path 106 and not limited to be an end point or terminal unit to the communication path 106. The second communication unit 1446 can include active and passive components, such as microelectronics or an antenna, for interaction with the communication path 106.

The second communication unit 1446 can include a second communication interface 1462. The second communication interface 1462 can be used for communication between the second communication unit 1446 and other functional units in the second device 104. The second communication interface 1462 can receive information from the other functional units or can transmit information to the other functional units.

The second communication interface 1462 can include different implementations depending on which functional units are being interfaced with the second communication unit 1446. The second communication interface 1462 can be implemented with technologies and techniques similar to the implementation of the second control interface 1468.

The second device 104 can include a second user interface 1442. The second user interface 1442 allows a user (not shown) to interface and interact with the second device 104. The second user interface 1442 can include a second user input (not shown). The second user input can include touch screen, gestures, motion detection, buttons, sliders, knobs, virtual buttons, voice recognition controls, or any combination thereof.

The second user interface 1442 can include a second display interface 1444. The second display interface 1444 can allow the user to interact with the second user interface 1442. The second display interface 1444 can include a display, a video screen, a speaker, or any combination thereof.

The second control unit 1452 can operate with the second user interface 1442 to display information generated by the cognitive evaluation and development system 100 on the second display interface 1444. The second control unit 1452 can also execute the second software 1460 for the other functions of the cognitive evaluation and development system 100, including receiving display information from the second storage unit 1456 for display on the second display interface 1444. The second control unit 1452 can further execute the second software 1460 for interaction with the communication path 106 via the second communication unit 1446.

The second device 104 can include a second location unit 1454. The second location unit 1454 can provide the location of the second device 104. The second location unit 1454 can access location information, current heading, and current speed of the second device 104, as examples.

The second location unit 1454 can be implemented in many ways. For example, the second location unit 1454 can function as at least a part of a global positioning system, an inertial navigation system, a cellular-tower location system, a pressure location system, or any combination thereof.

The second location unit 1454 can include a second location interface 1470. The second location interface 1470 can be used for communication between the second location unit 1454 and other functional units in the second device 104. The second location interface 1470 can also be used for communication that is external to the second device 104.

The second location interface 1470 can receive information from the other functional units or from external sources, or can transmit information to the other functional units or to external destinations. The external sources and the external destinations refer to sources and destinations external to the second device 104.

The second location interface 1470 can include different implementations depending on which functional units or external units are being interfaced with the second location unit 1454. The second location interface 1470 can be implemented with technologies and techniques similar to the implementation of the second control interface 1468.

The second device 104 can include a second position unit 1448. The second position unit 1448 can provide the position, motion, and orientation of the second device 104. The second position unit 1448 can access position information of the second device 104 including tilt, angle, direction, orientation, rotation, motion, acceleration, or a combination thereof.

The second position unit 1448 can be implemented in many ways. For example, the second position unit 1448 can be an accelerometer, a gyroscopic system, a MEMS system, an electrical contact system, an optical orientation system, or a combination thereof.

The second position unit 1448 can include a second position interface 1464. The second position interface 1464 can be used for communication between the second position unit 1448 and other functional units in the second device 104. The second position interface 1464 can also be used for communication that is external to the second device 104.

The second position interface 1464 can receive information from the other functional units or from external sources, or can transmit information to the other functional units or to external destinations. The external sources and the external destinations refer to sources and destinations external to the second device 104.

The second position interface 1464 can include different implementations depending on which functional units or external units are being interfaced with the second position unit 1448. The second position interface 1464 can be implemented with technologies and techniques similar to the implementation of the second control interface 1468.

The second device 104 can include a second imaging unit 1458. The second imaging unit 1458 can capture optical information at the second device 104 such as pictures, images, video, or a combination thereof. The second imaging unit 1458 can include a digital camera, optical sensor, video camera, drawing surface, or a combination thereof.

The second imaging unit 1458 can include a second imaging interface 1474. The second imaging interface 1474 can be used for communication between the second imaging unit 1458 and other functional units in the second device 104. The second imaging interface 1474 can also be used for communication that is external to the second device 104.

The second imaging interface 1474 can include different implementations depending on which functional units or external units are being interfaced with the second imaging unit 1458. The second imaging interface 1474 can be implemented with technologies and techniques similar to the implementation of the second control interface 1468.

The second device 104 can include a second audio unit 1450. The second audio unit 1450 can capture sound or other audio information at the second device 104. The second audio unit 1450 can include a digital microphone, audio sensor, or a combination thereof.

The second audio unit 1450 can include a second audio interface 1466. The second audio interface 1466 can be used for communication between the second audio unit 1450 and other functional units in the second device 104. The second audio interface 1466 can also be used for communication that is external to the second device 104.

The second audio interface 1466 can include different implementations depending on which functional units or external units are being interfaced with the second audio unit 1450. The second audio interface 1466 can be implemented with technologies and techniques similar to the implementation of the second control interface 1468.

For illustrative purposes, the second device 104 can be partitioned having the second user interface 1442, the second storage unit 1456, the second control unit 1452, and the second communication unit 1446, although it is understood that the second device 104 can have a different partition. For example, the second software 1460 can be partitioned differently such that some or all of its function can be in the second control unit 1452 and the second communication unit 1446. Also, the second device 104 can include other functional units, not shown in FIG. 14 for clarity.

The first communication unit 1406 can couple with the communication path 106 to send information to the second device 104. The second device 104 can receive information from the first communication unit 1406 in the second communication unit 1446 over the communication path 106.

The second communication unit 1446 can couple with the communication path 106 to send information to the first device 102. The first device 102 can receive information in the second communication unit 1446 from first communication unit 1406 over the communication path 106.

The functional units in the first device 102 can work individually and independently of the other functional units. For illustrative purposes, the cognitive evaluation and development system 100 is described by operation of the first device 102. It is understood that the first device 102 can operate any of the modules and functions of the cognitive evaluation and development system 100. For example, the first device 102 can be described to operate the first control unit 1412.

The functional units in the second device 104 can work individually and independently of the other functional units. For illustrative purposes, the cognitive evaluation and development system 100 can be described by operation of the second device 104. It is understood that the second device 104 can operate any of the modules and functions of the cognitive evaluation and development system 100. For example, the second device 104 is described to operate the second control unit 1452.

The cognitive evaluation and development system 100 can be executed by the first control unit 1412, the second control unit 1452, or a combination thereof. For illustrative purposes, the cognitive evaluation and development system 100 is described by operation of the first device 102 and the second device 104. It is understood that the first device 102 and the second device 104 can operate any of the modules and functions of the cognitive evaluation and development system 100. For example, the first device 102 is described to operate the first control unit 1412, although it is understood that the second device 104 can also operate the first control unit 1412.

The cognitive evaluation and development system 100 can include the first audio unit 310. However, it is understood that the functionality of the first audio unit 310 can be performed with the second audio unit 1450.

The cognitive evaluation and development system 100 can include the first imaging unit 302. However, it is understood that the function of the first imaging unit 302 can be performed with the second imaging unit 1458.

The cognitive evaluation and development system 100 can include the first display interface 210. However, it is understood that the functionality of the first display interface 210 can be performed with the second display interface 1444.

Referring now to FIG. 15, therein is shown a control flow 1501 of the cognitive evaluation and development system 100 of FIG. 1. The control flow 1501 describes the operation of the cognitive evaluation and development system 100.

The cognitive evaluation and development system 100 can include a setup module 1502. The setup module 1502 can prepare the cognitive evaluation and development system 100 for operation including displaying an introduction video, receiving the user profile 1204 of FIG. 12, and receiving the health profile 1304 of FIG. 13.

The setup module 1502 can display an introduction video on the first device 102 of FIG. 1 when the cognitive evaluation and development system 100 is launched. The initialization video can provide information including how to operate the cognitive evaluation and development system 100.

The setup module 1502 can present the user survey 1202 of FIG. 12 on the first device 102. The user survey 1202 is a set of informational prompts used to identify the user. The setup module 1502 can receive the user profile 1204 based on responses to the user survey 1202. The setup module 1502 can push a notification response to the first display interface 210 of FIG. 2 of the first device 102 when the user profile 1204 has been completed.

The setup module 1502 can save the user profile 1204 in a local database or to a remote storage system, such as a cloud storage system. For example, the user can complete the user survey 1202 by entering text information in response to the questions.

The user survey 1202 can be used to create the user identification 1206 of FIG. 12. The user identification 1206 is a value used to uniquely identify the user. The information in the cognitive evaluation and development system 100 associated with the user can be tagged with the user identification 1206.

The setup module 1502 can present the health survey 1302 of FIG. 13 on the first device 102. The setup module 1502 can receive the health profile 1304 based on the health survey 1302.

The setup module 1502 can save the health profile 1304 in a local database or to a remote storage system, such as the cloud storage system. For example, the health survey 1302 can include questions about the user's physical and mental health. The health survey 1302 can be used to classify the cognitive status of the user. The health survey 1302 can be used to measure changes in the cognitive status of the user. The setup module 1502 can push a notification response to the first display interface 210 of the first device 102 when the health profile 1304 has been completed.

The cognitive evaluation and development system 100 can include a cognitive puzzle module 1504. The cognitive puzzle module 1504 can present the cognitive puzzle 202 of FIG. 2 for the user to solve for enabling the video tiles 204 of FIG. 2.

The cognitive puzzle module 1504 can display the cognitive puzzle 202 having the video tiles 204 representing the solution picture 208 of FIG. 2 on the first display interface 210. Each of the video tiles 204 can include one of the tile graphic 206 of FIG. 2 representing a portion of the solution picture 208. All of the video tiles 204 taken together can form a representation of the solution picture 208.

Each of the video tiles 204 can include a link to one of the media clip 602 of FIG. 6. Activating the link can display the media clip 602 associated with one of the video tiles 204. The link of the video tiles 204 can initially be disabled and become enabled when the cognitive puzzle 202 is solved.

When the video tiles 204 are repositioned to form the solution picture 208, additional digital content can be activated including enabling the links associated with each of the video tiles 204. The cognitive puzzle module 1504 can award neuron points to the user for solving the cognitive puzzle 202. The neuron points are an in-application currency that can be used to interact with the cognitive evaluation and development system 100. The neuron points can be used to measure progress, unlock additional content, keep the user engaged and motivated, and measure cognitive status.

Accumulated user neuron points grants the user access to reserved content, certain media clips, advanced cognitive puzzles, and, or other application functionality. Additional neuron points also may be used by the user to access other digital content. Neuron currency is also a point system that measures the user's participation level using the application for tracking cognitive development and is a way to monitor an individual user's cognitive progress over time and to compare an individual user's participation level with other application users. Neuron points can be used to motivate the application user to continue to participate in the application cognitive exercises and to report health and cognitive status over time.

The cognitive puzzle 202 can be implemented in a variety of ways. For example, the video tiles 204 can initially be presented in a scrambled sequence that does not show a clear representation of the solution picture 208. The video tiles 204 can be unscrambled to form a sequence that shows the solution picture 208.

The video tiles 204 can be unscrambled by rearranging the position of the video tiles 204. The video tiles 204 may be rearranged in a variety of ways. For example, the video tiles 204 can be rearranged by swapping two of the video tiles 204, moving one of the video tiles 204, sliding one of the video tiles 204, or a combination thereof. The cognitive puzzle 202 can be solved when the video tiles 204 are arranged to form the solution picture 208.

In another example, the cognitive puzzle 202 can be solved by rotating the video tiles 204 individually to form the solution picture 208. The video tiles 204 can be rotated by selecting one of the video tiles 204. In yet another example, the cognitive puzzle 202 can be solved by dragging one of the video tiles 204 to a new location.

It has been discovered that solving the cognitive puzzle 202 by arranging the video tiles 204 to form the solution picture 208 can improve cognitive status by increasing the level of concentration required to solve the cognitive puzzle 202. Identifying, selecting, and moving the video tiles 204 in an orderly fashion can increase the level of focus for the period of time required to solve the cognitive puzzle 202.

The cognitive evaluation and development system 100 can include a select video tile module 1506. The select video tile module 1506 can allow the user to choose which of the video tiles 204 to select to initiate the associated display of the media clip 602.

The select video tile module 1506 can highlight or mark the video tiles 204 that have been previously selected. The select video tile module 1506 can receive input from the user to select one of the video tiles 204. When one of the video tiles 204 is selected, the cognitive evaluation and development system 100 can display the media clip 602 on the first device 102.

The cognitive evaluation and development system 100 can include a present media clip module 1508. The present media clip module 1508 can activate a media player and display the media clip 602 associated with selected one of the video tiles 204. The media player can allow the user to control the display of the media clip 602 including play, rewind, fast forward, playback speed, next, previous, or a combination thereof.

The media clip 602 can be linked to one of the video tiles 204. Selecting one of the video tiles 204 can cause the media clip 602 to be played. After the media clip 602 is displayed, the control flow can pass to a provide task module 1510.

The media clip 602 can include content intended to facilitate the evaluation and development of the cognitive status of the user. For example, the media clip 602 can include a video of a person standing at the seashore at sunset with boats and birds in the background. The cognitive task 702 of FIG. 7 can include a request to create a video showing the birds in an emotional context, such as sad birds or happy birds.

The media clip 602 can be provided in a variety of ways. For example, the media clip 602 can include the user generated content 802 of FIG. 8 created by users. In another example, the media clip 602 can include pre-defined images intended to produce a specific cognitive response.

The media clip 602 can include images, photos, videos, graphics, and audio, such as displays of scenes in nature or human interactions, which are intended to expand a user's thinking and induce a peaceful state of mind. For example, within the media clip 602, a message may be displayed or spoken that prompts the user to participate in a particular guided cognitive activity, such as “How many jellyfish do you see?” in a scene with jellyfish, or “Look for the yellow kayaks.” in a scene with boats.

The media clip 602 can also include images, photos, videos, graphics, and audio, such as depictions of people doing a particular activity, to model a cognitive promoting behavior, to inform and motivate the application user to engage in a similar activity or process. The media clip 602 can include specific instructions for teaching users about their cognitive or physical health, along with exercises, and tools to improve cognitive development.

The media clip 602 can also include content designed to facilitate conversations with the user's physician relating to the user's health status, symptoms experienced, medical history and progress with specific cognitive and health exercises. The media clip 602 can be shared with and viewed by the user's physician to inform the user's physician of a range of tools that may benefit the application user. The duration of the media clip can be limited, such as a length of 90 seconds or less, to focus the user's thinking for a concentrated period of time on a particular cognitive activity followed by a reflection period.

Displaying the media clip 602 can engage multiple senses of the user simultaneously to enhance cognitive development. For example, displaying the media clip 602 can engage the user's visual and auditory senses, while conveying an emotional perception.

The media clip 602 can be presented in a curated and orderly manner that does not overwhelm the application user. For example, some users may find it difficult to digest and process large kinds of cognitive stimulation at a given time, so the media clip 602 can be presented in segments to prevent overwhelming the user.

The media clip 602 can display content in a guided fashion, such as in a “show and tell” or illustration mode, to show the user how to do a particular exercise, activity or task in an engaging and emotional context. The media clip 602 can be viewed repeated times, paused, and replayed by the user. Control over the display of the media clip 602 allows the user to view and re-watch the video clip based on the user's own preferences and needs.

The media clip 602 can also provide content, such as beautiful scenes in nature or human interactions, that may be absent in the user's own environment or experiences. Presenting such content can be used to induce a state of mind to experience a feeling, an emotion, or a cognitive process without having to physically be in the same place or moment in time.

The cognitive evaluation and development system 100 can include the provide task module 1510. The provide task module 1510 can generate the cognitive task 702 associated with the media clip 602 and display the cognitive task 702 to the user.

The provide task module 1510 can generate the cognitive task 702 in a variety of ways. For example, the cognitive task 702 can be retrieved from a pre-defined table linking the media clip 602 the cognitive task 702. The selection of the cognitive task 702 can be based on the media clip 602, the health profile 1304, the user profile 1204, previous stored entries of the user generated content 802 from the user, the location of the user, the cognitive state of the user, or a combination thereof. The cognitive state can be an enumerated value associated with the user identification 1206 and the health profile 1304. In an illustrative example, the cognitive task 702 can be the phrase “take a photograph of a sunset” which can be stored in a table stored in the content management system 108 of FIG. 1 and associated with the media clip 602 showing a sunset or a sunrise.

In another example, the cognitive task 702 can be formed dynamically by categorizing the media clip 602 based on a pre-defined set of elements within the media clip 602 and generating the cognitive task 702 based on one of the elements identified within the media clip 602. In another illustrative example, the media clip 602 can include images of a person standing in front of the seashore with boats and birds in the background.

The provide task module 1510 can select one of the elements, such as people, water, seashore, boats, or birds, and generate the cognitive task 702 based on one or more of the elements in the media clip 602. The provide task module 1510 can select the element of “birds” using a selection mechanism and generate the cognitive task 702 of “make an audio and video recording of birds flying peacefully”. The selection mechanism can be implemented in a variety of ways, such as randomly, based on a weighted table, based on an external information feed, based on the user profile 1204, based on the health profile 1304, based on the media clip 602 content, or a combination thereof.

The provide task module 1510 can display the cognitive task 702 on the first display interface 210. The provide task module 1510 can display the cognitive task 702 in a variety of ways. For example, the cognitive task 702 can be displayed as a textual message on the first device 102. In another example, the cognitive task 702 is provided as an audio message played on the first device 102. In yet another example, the cognitive task 702 can be provided as a video message and displayed using the media player on the first device 102.

The cognitive task 702 can specify the subject matter and the media type of the user generated content 802. For example, the cognitive task 702 can specify that the user generated content 802 include subject matter elements such as objects, sounds, the time of day, seasonal elements, size of elements, or a combination thereof. The cognitive task 702 can specify the media type of the user generated content 802, such as still photograph, video images, audio recordings, text information, or a combination thereof.

The cognitive evaluation and development system 100 can include an acquire user generated content module 1512. The acquire user generated content module 1512 can allow the user create the user generated content 802 requested in the cognitive task 702. The cognitive task 702 can be an assignment to create a particular media type of a particular subject matter.

The cognitive task 702 can specify that the user create the user generated content 802 in response to the media clip 602 that was viewed by the user. The cognitive task 702 can specify a very detailed type of the user generated content 802 or a less detailed type of the user generated content 802 depending on the level of the cognitive status of the user or other consideration.

The acquire user generated content module 1512 can support the creation of the user generated content 802 in a variety of ways. For example, the acquire user generated content module 1512 can couple with the first imaging unit of the device to capture a photograph or video recording and send the user generated content 802 to the content management system 108.

In another example, the acquire user generated content module 1512 can couple with the first audio unit of the device to create an audio recording and send the user generated content 802 to the content management system. In yet another example, the acquire user generated content module 1512 can couple with the user interface of the first device 102 to receive text input to create the user generated content 802 that can be sent to the content management system 108.

The acquire user generated content module 1512 can associate the user generated content 802 with the location or position of the first device 102 at the time of creation of the user generated content 802. The acquire user generated content module 1512 can couple with the first location unit 1414 of FIG. 14 of the first device 102 to tag the user generated content 802 with a location. For example, the location of the beach where the user generated content 802 of a boat scene can be associated with the digital photograph of the boat scene.

The acquire user generated content module 1512 can be coupled with the first position unit 1408 of FIG. 14 of the first device 102 to tag the user generated content 802 with the orientation and position of the first device 102 at the time the user generated content 802 is created. In another example, the orientation of the first device 102 can indicate that the user generated content 802 of the video recording was created while the device was being held upside down.

The acquire user generated content module 1512 can allow the user generated content 802 to be tagged with a user note. The user can create the user note that can be associated with the user generated content 802 and stored in the content management system 108. For example, the user can associate a text message with the user generated content 802 to explain how and why a particular picture was taken. Although the user note can be a text message, it is understood that the user note can be any type of media including an audio recording, a video recording, text, graphic, or a combination thereof.

It has been discovered that creating the user generated content 802 based on the cognitive task 702 associated with the media clip 602 can provide information about the users cognitive status by determining the level of compliance with the cognitive task 702. Detecting the presence of the subject matter requested in the cognitive task 702 in the user generated content 802 can provide a measure of the level of compliance of the user and provide an indication of the cognitive status of the user.

It has been discovered that creating the user generated content 802 can improve the level of the measure of the cognitive status of the user by requiring the user to perform the cognitive task 702. Performing the cognitive task 702 of creating the user generated content 802 requires a measurable level of cognitive activity that can provide a measurable representation of the user's cognitive status. Monitoring and tracking the changes in the level of cognitive status can be used to coordinate efforts to change the cognitive status of the user using feedback mechanisms.

It has been discovered that the effort, exertion and activity required to create and capture the user generated content 802 aids in cognitive development. The creation of the user generated content 802 is a cognitive exercise that can modify the user's cognitive status.

It has been discovered that associating the user generated content 802 with the location and position at the time of creation improves the quality and context of the cognitive response message provided to the user. The location and position of the first device 102 can provide additional contextual information about the user generated content 802 that can be used to generate the cognitive response message 1002 of FIG. 10 having more relevance to the user.

The cognitive evaluation and development system 100 can include a cognitive response module 1514. The cognitive response module 1514 can provide the cognitive response message 1002 in response to the user generated content 802 specified in the cognitive task 702.

The cognitive response message 1002 is a contextual response to the user generated content 802 intended to affect the cognitive status of the user. The cognitive response message 1002 is an individualized and relevant response based on analyzing the user generated content 802 provided by the user. The cognitive response module 1514 can retrieve the user generated content 802 associated with the cognitive task 702 from the content management system 108, analyze the user generated content 802, and generate the cognitive response message 1002 to be provided to the user.

For example, the cognitive response message 1002 can be the push notification 902 of FIG. 9 displayed on the first device 102 telling the user that the user generated content 802 was formed correctly based on the detection of the subject matter elements and the media type. In another example, the cognitive response message 1002 can be an audio message intended to alleviate frustration if the media type 804 of FIG. 8 was incorrect. In yet another example, the cognitive response message 1002 can be a video clip instructing the user to speak to a service provider or health professional based on the note attached to the user generated content 802.

The cognitive response module 1514 can generate the cognitive response message 1002 in a variety of ways. The cognitive response message 1002 can be generated in response to computer analysis of the user generated content 802, the media clip 602, the cognitive task 702, or a combination thereof. The cognitive response message 1002 can be generated using an automated rule-based system, a statistical data engine of previous responses, a pre-defined table, manually, or a combination thereof.

For example, the cognitive response module 1514 can generate and push the cognitive response message 1002 manually created by an individual based on the computer analysis of the user generated content 802, the media clip 602, the automated rule-based system, statistical data engine of previous responses, a pre-defined table, or a combination thereof. The cognitive response message 1002 can provide the user with a contextually relevant response message.

The cognitive response message 1002 can provide a portion of a feedback mechanism to assist the user in managing the measured value of their cognitive status and for motivating the user to continue to engage in cognitive activities. The cognitive evaluation and development system 100 can retrieve the user generated content 802 previously stored in the cognitive evaluation and development system 100 to compare with the user generated content 802 recently entered to evaluate the differences and generate the cognitive response message 1002 based on the differences.

It has been discovered that the cognitive response message 1002 generated based on feedback from the user generated content 802 previously stored can be more effective for managing cognitive status and development by being contextually relevant to the user. Utilizing the feedback from the user generated content 802 can allow improved feedback based on multiple data points.

It has been discovered that the cognitive evaluation and development system 100 provides increased levels of compliance and usage when installed on the device 102. The user's compliance with regular and frequent cognitive exercise and other health promoting behaviors increases because of the close and frequent proximity of the device 102 to the user. The cognitive evaluation and development system 100 captures important and vital health status data that can be shared with health care providers to more accurately report health status and cognitive development progress.

The cognitive evaluation and development system 100 can include a store content module 1516. The store content module 1516 can allow the user generated content 802 to be shared to a social community or stored privately in the content management system 108.

The store content module 1516 can display the share content message 1102 of FIG. 11 on the first device 102. If the user selects the share content message 1102, then the user generated content 802 stored in the content management system 108 can be shared to other users in the social community.

The store content module 1516 can display the no-share content message 1104 of FIG. 11 on the first device 102. If the user selects the no-share content message 1104, then the user generated content 802 stored in the content management system 108 can be marked private and not made available to other users in the social community or with other application users.

The user generated content 802 shared to the social community can be reviewed and used by other members of the social community. The user generated content 802 can be used to form the media clip 602. The media clip 602 formed from the user generated content 802 can be tagged with information based on the cognitive status of the user. The user generated content 802 previously stored in the content management system 108 can be used to compare to the user generated content 802 that has recently been entered to evaluate and measure the values of the cognitive status of the user at a particular time and over a period of time.

The physical transformation from receiving and responding to the cognitive task 702 results in movement in the physical world, such as people using the first device 102 of FIG. 1 to accomplish the cognitive task 702, such as taking a picture for forming the user generated content 802 based on the operation of the cognitive evaluation and development system 100. As the movement in the physical world occurs, the movement itself creates additional information, such as the creation of the user generated content 802 that can be shared and reused by other users for continued operation of the cognitive evaluation and development system 100 and to continue movement in the physical world.

The first software 1420 of FIG. 14 of the first device 102 can include the cognitive evaluation and development system 100. For example, the first software 1420 can include the setup module 1502, the cognitive puzzle module 1504, the select video tile module 1506, the present media clip module 1508, the provide task module 1510, the acquire user generated content module 1512, the cognitive response module 1514, and the store content module 1516.

The first control unit 1412 of FIG. 14 can execute the first software 1420 for the cognitive puzzle module 1504 to generate the cognitive puzzle 202. The first control unit 1412 can execute the first software 1420 for the select video tile module 1506 to select the video tile 204 linked to the media clip 602. The first control unit 1412 can execute the first software 1420 for the present media clip module 1508 to display the media clip 602. The first control unit 1412 can execute the first software 1420 for the acquire user generated content module 1512 to create and capture the user generated content 802, such as a picture, video clip, text, or a combination thereof.

The second software 1460 of FIG. 14 of the second device 104 of FIG. 1 can include the cognitive evaluation and development system 100. For example, the second software 1460 can include the setup module 1502, the cognitive puzzle module 1504, the select video tile module 1506, the present media clip module 1508, the provide task module 1510, the acquire user generated content module 1512, the cognitive response module 1514, and the store content module 1516.

The second control unit 1452 of FIG. 14 can execute the second software 1460 for the provide task module 1510 to provide the cognitive task 702 based on the media clip 602. The second control unit 1452 can execute the second software 1460 for the cognitive response module 1514 to provide the cognitive response message 1002 based on the user generated content 802. The second control unit 1452 can execute the second software 1460 for the store content module 1516 to store the user generated content 802 on a local storage unit or in the content management system 108.

The cognitive evaluation and development system 100 can be partitioned between the first software 1420 and the second software 1460. For example, the second software 1460 can include the cognitive puzzle module 1504, the select video tile module, the present media clip module 1508, and the acquire user generated content module 1512. The second control unit 1452 can execute modules partitioned on the second software 1460 as previously described.

The first software 1420 can include the provide task module 1510, the cognitive response module 1514, and the store content module 1516. Depending on the size of the first storage unit 1416 of FIG. 14, the first software 1420 can include additional modules of the cognitive evaluation and development system 100. The first control unit 1412 can execute the modules partitioned on the first software 1420 as previously described.

The first control unit 1412 can operate the first communication unit 1406 of FIG. 14 to send the user generated content 802 to the second device 104. The first control unit 1412 can operate the first software 1420 to operate the first imaging unit 302 of FIG. 3 and the first audio unit 310 of FIG. 3 to create the user generated content 802. The second communication unit 1446 of FIG. 14 can send the cognitive task 702 and the cognitive response message 1002 to the first device 102 through the communication path 106.

The cognitive evaluation and development system 100 describes the module functions or order as an example. The modules can be partitioned differently. For example, the cognitive puzzle module 1504 and the select video tile module 1506 can be combined. Each of the modules can operate individually and independently of the other modules.

Furthermore, data generated in one module can be used by another module without being directly coupled to each other. For example, the cognitive response module 1514 can receive the user generated content 802 from the acquire user generated content module 1512. The setup module 1502, the cognitive puzzle module 1504, the select video tile module 1506, the present media clip module 1508, the provide task module 1510, the acquire user generated content module 1512, the cognitive response module 1514, and the store content module 1516 can be implemented as hardware accelerators (not shown) within the first control unit 1412 or the second control unit 1452, or can be implemented in as hardware accelerators (not shown) in the first device 102 or the second device 104 outside of the first control unit 1412 or the second control unit 1452.

Referring now to FIG. 16, therein is shown a flow chart of a method 1600 of operation of the cognitive evaluation and development system 100 of FIG. 1 in a further embodiment of the present invention. The method 1600 includes: presenting a cognitive puzzle in a block 1602; selecting a video tile of the cognitive puzzle, the video tile enabled by solving the cognitive puzzle in a block 1604; presenting a media clip linked to the video tile, the media clip for displaying on a device in a block 1606; providing a cognitive task linked to the media clip in a block 1608; acquiring a user generated content in response to the cognitive task in a block 1610; and presenting a cognitive response message based on the user generated content for displaying on the device in a block 1612.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance. These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a cognitive evaluation and development system comprising:
presenting a cognitive puzzle;
selecting a video tile of the cognitive puzzle, the video tile enabled by solving the cognitive puzzle;
presenting a media clip linked to the video tile, the media clip for displaying on a device;
providing a cognitive task linked to the media clip;
acquiring a user generated content in response to the cognitive task; and
presenting a cognitive response message based on the user generated content for displaying on the device.

2. The method as claimed in claim 1 wherein presenting the cognitive puzzle includes arranging the video tiles in a scrambled sequence and solving the cognitive puzzle by positioning the video tiles to form a solution picture.

3. The method as claimed in claim 1 wherein acquiring the user generated content includes forming the user generated content with an imaging unit, an audio unit, or a combination thereof.

4. The method as claimed in claim 1 wherein presenting the cognitive puzzle includes:
forming the video tiles with a tile graphic having a portion of a solution picture; and
arranging the video tiles to form the solution picture.

5. The method as claimed in claim 1 wherein presenting the cognitive response message includes generating the cognitive response message based on the similarity between the user generated content and the media clip.

6. A method of operation of a cognitive evaluation and development system comprising:
presenting a cognitive puzzle having a solution picture;
selecting a video tile of the cognitive puzzle, the video tile enabled by solving the cognitive puzzle by forming the solution picture;
presenting a media clip linked to the video tile, the media clip for displaying on the device;
providing a cognitive task linked to the media clip;
acquiring a user generated content in response to the cognitive task; and
presenting a cognitive response message based on the user generated content and the cognitive task for displaying on the device.

7. The method as claimed in claim 6 wherein presenting the cognitive puzzle includes arranging the video tiles in a scrambled sequence and solving the cognitive puzzle by positioning the video tiles to form a solution picture.

8. The method as claimed in claim 6 wherein acquiring the user generated content includes receiving the user generated content as a digital image, a video recording, a text message, or an audio recording.

9. The method as claimed in claim 6 wherein presenting the cognitive response message includes generating the cognitive response message based on the similarity between the user generated content and the media clip.

10. The method as claimed in claim 6 wherein acquiring the user generated content includes:
forming the video tiles with a tile graphic having a portion of a solution picture; and
arranging the video tiles to form the solution picture.

11. A cognitive evaluation and development system comprising:
a cognitive puzzle having a video tile;
a media clip linked to the video tile;
a cognitive task based on the media clip;
a user generated content based on the cognitive task; and
a cognitive response message based on the user generated content for displaying on the device.

12. The system as claimed in claim 11 wherein the cognitive puzzle includes the video tiles arranged in a scrambled sequence.

13. The system as claimed in claim 11 wherein the user generated content is formed from an imaging unit, an audio unit, or a combination thereof.

14. The system as claimed in claim 11 wherein the cognitive puzzle includes:
the video tiles with a tile graphic having a portion of a solution picture; and
the video tiles arranged to form the solution picture.

15. The system as claimed in claim 11 wherein the cognitive response message is based on the similarity between the user generated content and the media clip.

16. The system as claimed in claim 11 wherein:
the cognitive puzzle includes a solution picture;
the user generated content is based on the cognitive task and the media clip; and
the cognitive response message is based on the user generated content and the cognitive task for displaying on the device.

17. The system as claimed in claim 16 wherein the cognitive puzzle is arranged in a scrambled sequence.

18. The system as claimed in claim 16 wherein the user generated content is a digital image, a video recording, a text message, or an audio recording.

19. The system as claimed in claim 16 wherein the cognitive response message is based on the similarity between the user generated content and the media clip.

20. The system as claimed in claim 16 wherein the user generated content includes:
the video tiles with a tile graphic having a portion of the solution picture; and
the video tiles arranged to form the solution picture.
